(19) United States
(12) Patent Application Publication
(10) Pub. No.: US 2003/0108731 A1
(43) Pub. Date: Jun. 12, 2003

(54) Molding of fluid permeable flexible graphite components for fuel cells

(76) Inventors: Robert Angelo Mercuri, Seven Hills, OH (US); Matthew George Getz, Medina, OH (US); Thomas William Weber, Cleveland, OH (US)

Correspondence Address: Waddey & Patterson, P.C., Bank of America Plaza, 414 Union Street, Suite 2020, Nashville, TN, 37219, US

(21) Appl. No.: 10/273,756

(22) Filed: Oct. 18, 2002

Related U.S. Application Data
(63) Continuation-in-part of application No. 09/490,975, filed on Jan. 24, 2000, now Pat. No. 6,506,484.
(63) Continuation-in-part of application No. 09/490,210, filed on Jan. 24, 2000, now Pat. No. 6,468,686.
(63) Continuation-in-part of application No. 10/105,753, filed on Mar. 25, 2002.
Application No. 10/105,753 is a continuation of application No. 09/545,956, filed on Apr. 10, 2000, now Pat. No. 6,413,671.
Application No. 10/105,753 is a continuation of application No. 09/675,027, filed on Sep. 28, 2000, now Pat. No. 6,479,182.
Application No. 10/105,753 is a continuation of application No. 09/549,865, filed on Apr. 14, 2000, now Pat. No. 6,528,199.

(51) Int. Cl. B32B 3/26

(52) U.S. Cl. 428/304.4

(57) ABSTRACT

Materials and methods of manufacturing materials useful in the forming of fuel cell components are disclosed. A mass of expanded particles of natural graphite is molded into a foraminous sheet having parallel opposed first and second surfaces and having a plurality of transverse fluid channels passing through the sheet between the first and second parallel opposed surfaces. The particles of natural graphite may be either virgin particles, recycled particles or a blend thereof.

This application is a continuation-in-part of each of the following co-pending applications, the details of which are incorporated herein by reference:

1) U.S. patent application Ser. No. 09/490,975, filed Jan. 24, 2000;

2) U.S. patent application Ser. No. 09/490,210, filed Jan. 24, 2000;

3) U.S. patent application Ser. No. 10/105,753, filed Mar. 25, 2002, which is a continuation of U.S. patent application Ser. No. 09/545,956, filed Apr. 10, 2000;

4) U.S. patent application Ser. No. 09/675,027, filed Sep. 28, 2000; and

5) U.S. patent application Ser. No. 09/549,865, filed Apr. 14, 2000.

### TECHNICAL FIELD

The present invention relates to processes for the manufacturing of materials useful in forming fuel cell components, and more particularly relates to such processes in which the materials are molded from a mass of expanded particles of natural graphite.

### BACKGROUND OF THE ART

An ion exchange membrane fuel cell, more specifically a proton exchange membrane (PEM) fuel cell, produces electricity through the chemical reaction of hydrogen and oxygen in the air. Within the fuel cell, electrodes denoted as anode and cathode surround a polymer electrolyte to form what is generally referred to as a membrane electrode assembly, or MEA. Oftentimes, the electrodes also function as the gas diffusion layer (or GDL) of the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell includes a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

Materials useful in forming fuel cell components such as electrodes are often manufactured from graphite materials. Particularly such components are often formed from flexible sheet graphite material, which has most often been formed through calendering processes.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional such as thermal and electrical conductivity.

Briefly, graphites may be characterized as laminated structures of carbon, that is, structures consisting of superposed layers or laminae of carbon atoms joined together by weak van dear Wails forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van dear Wails forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal and electrical conductivity due to orientation of the expanded graphite particles and graphite layers substantially parallel to the opposed faces of the sheet resulting from very high compression. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc. The flexible graphite sheet material exhibits an appreciable degree of anisotropy due to the alignment of graphite particles parallel to the major opposed, parallel surfaces of the sheet, with the degree of anisotropy increasing upon compression of the sheet material to increase orientation. In compressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

One process that has recently been proposed for the manufacture of the electrodes of the membrane electrode assembly involved mechanically impacting a sheet of flexible graphite material to form channels through the thickness of the sheet, and/or to form open grooves in the surface of the sheet. Such processes are shown for example in International Publication WO 01/54213 A1, which is assigned to the assignee of the present invention, and the details of which are incorporated herein by reference.

There is a continuing need for further and improved methods of manufacturing such materials.

### SUMMARY OF THE INVENTION

The present invention provides methods for manufacturing materials useful in forming fuel cell components, wherein the materials are molded from a mass of expanded particles of natural graphite. The particles of natural graphite may be either virgin material comprising expanded natural graphite flakes or recycled material comprising comminuted graphite sheets, or a blend thereof.

By the present method the mass of expanded particles of natural graphite is molded into a foraminous sheet having parallel opposed first and second surfaces and having a plurality of transfer fluid channels passing through the sheet between the first and second parallel opposed surfaces. Preferably the molding is accomplished by compression molding wherein the mass of expanded graphite particles is confined between a mold plunger and a mold cavity.

The molding of the material results in a material which has an internal structure which is less anisotropic than the internal structure of a calendered flexible graphite sheet, thus resulting in a greater through thickness electrical conductivity for the molded material. This provides significant advantages in certain applications of the material as contrasted to the use of a calendered graphite sheet.

Accordingly, it is an object of the present invention to provide improved methods of manufacture of materials useful in the forming of fuel cell components.

Another object of the present invention is to provide a method for the molding of a mass of expanded particles of natural graphite into a material useful for forming a fuel cell component.

Another object of the present invention is the provision of graphite materials having increased through thickness electrical and thermal conductivities as compared to calendered graphite sheet materials of comparable dimensions.

And another object of the present invention is the provision of methods of molding such materials including complex shapes having channels extending through the thickness of the material and having various arrangements of grooves communicating some or all of the channels across the major surfaces of the material.

And another object of the present invention is the provision of improved materials useful in forming a fuel cell component.

Other and further objects, features, and advantages of the present invention will be readily apparent to those skilled in the art, upon a reading of the following disclosure when taken in conjunction with the accompanying drawings.

### BRIEF DESCRIPTION OF THE DRAWINGS

FIG. 1 is a plan view of a foraminous sheet molded from a mass of expanded particles of natural graphite, and including a plurality of channels passing between the major surfaces of the sheet and a plurality of grooves interconnecting the channels.

FIG. 1(A) is a perspective view of one protrusion element of a mold plunger of FIG. 3 for forming a square shaped channel.

FIG. 2 is a cross-sectional view taken along line 2-2 of FIG. 1 showing the internal construction of the molded sheet.

FIGS. 2(A), 2(B) and 2(C) are views similar to FIG. 1(A) showing triangular, circular and diamond shaped channel forming protrusion elements.

FIG. 3 is a schematic cross-section view of a compression mold made up of an upper mold plunger and a lower mold cavity for compression molding the material of FIG. 1.

FIG. 3(A) is an elevation schematic view of a mold plunger having portions for forming surface grooves in the molded material.

FIG. 3(B) is a bottom view of the mold plunger of FIG. 3(A).

FIG. 3(C) is a perspective view of the molded material formed by the mold plunger of FIG. 3.

FIG. 3(D) is a perspective view of the material molded by the mold plunger of FIGS. 3(A) and 3(B).

FIG. 4 is a schematic sectioned view of a fuel cell incorporating electrodes formed from the material of FIG. 1.

FIG. 5 is a further view of the fuel cell of FIG. 4.

FIG. 6 is an enlarged view of a portion of the fuel cell of FIGS. 4 and 5 showing the placement of catalyst adjacent the electrodes.

FIG. 7 is a plan view of a modified sheet of material like that of FIG. 1, wherein an open groove has been molded in the surface of the material to provide a flow channel from an inlet to an outlet.

FIG. 8 is an elevation cross-section view of the material of FIG. 7 having a cover sheet thereon to enclose the open groove.

FIG. 9 is a perspective partly cutaway view of the assembly of FIG. 8.

FIGS. 10(A) and 10(B) are side-by-side photomicrographs of the internal structure of a prior art calendered graphite sheet material in FIG. 10(A) as compared to a compression molded graphite sheet material in FIG. 10(B). As is apparent in comparing FIGS. 10(A) and 10(B), the molded material of FIG. 10(B) is much less anisotropic than is the calendered prior art material of FIG. 10(A), thus providing an internal structure which leads to greater through thickness electrical and thermal conductivity for the molded material as compared to the calendered material.

### DETAILED DESCRIPTION OF THE INVENTION

Molding of Flexible Graphite Sheets from Worms

Graphite is a crystalline form of carbon comprising atoms covalently bonded in flat layered planes with weaker bonds between the planes. In obtaining source materials such as the above flexible sheets of graphite, particles of graphite, such as natural graphite flake, are typically treated with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as graphite prepared by chemical vapor deposition, high temperature pyrolysis of polymers, or crystallization from molten metal solutions, and the like. Natural graphite is most preferred.

The graphite starting materials for the flexible sheets used in the present invention may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than six weight percent. More preferably, the graphite employed for the present invention will have a purity of at least about 98%. In the most preferred embodiment, the graphite employed will have a purity of at least about 99%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the flakes are intercalated, any excess solution is drained from the flakes and the flakes are water-washed.

Alternatively, the quantity of the intercalation solution may be limited to between about 10 and about 40 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalated graphite flake with the organic reducing agent, the blend can be exposed to temperatures in the range of 25° to 125° C. to promote reaction of the reducing agent and intercalated graphite flake. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compression molded together into flexible sheets having small transverse openings that, unlike the original graphite flakes, can be formed and cut into various shapes, as hereinafter described.

Flexible graphite sheet and foil are coherent, with good handling strength, and are suitably compressed by, e.g. compression molding, to a thickness of about 0.025 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, or mixtures thereof. Suitable epoxy resin systems include those based on diglycidyl ether or bisphenol A (DGEBA) and other multifunctional resin systems; phenolic resins that can be employed include resole and novolak phenolics.

Molding of Flexible Graphite Sheets from Regrind Materials

Alternatively the molding processes of the present invention may utilize particles of reground flexible graphite sheets rather than freshly expanded worms. The sheets may be newly formed sheet material, recycled sheet material, scrap sheet material, or any other suitable source.

Also the processes of the present invention may use a blend of virgin materials and recycled materials.

The source material for recycled materials may be sheets or trimmed portions of sheets that have been compression molded as described above, or sheets that have been compressed with, for example, pre-calendering rolls, but have not yet been impregnated with resin. Furthermore, the source material may be sheets or trimmed portions of sheets that have been impregnated with resin, but not yet cured, or sheets or trimmed portions of sheets that have been impregnated with resin and cured. The source material may also be recycled flexible graphite PEM fuel cell components such as flow field plates or electrodes. Each of the various sources of graphite may be used as is or blended with natural graphite flakes.

Once the source material of flexible graphite sheets is available, it can then be comminuted by known processes or devices, such as a jet mill, air mill, blender, etc. to produce particles. Preferably, a majority of the particles have a diameter such that they will pass through 20 U.S. mesh; more preferably a major portion (greater than about 20%, most preferably greater than about 50%) will not pass through 80 U.S. mesh. Most preferably the particles have a particle size of no greater than about 20 mesh. It may be desirable to cool the flexible graphite sheet when it is resin-impregnated as it is being comminuted to avoid heat damage to the resin system during the comminution process.

The size of the comminuted particles may be chosen so as to balance machinability and formability of the graphite article with the thermal characteristics desired. Thus, smaller particles will result in a graphite article which is easier to machine and/or form, whereas larger particles will result in a graphite article having higher anisotropy, and, therefore, greater in-plane electrical and thermal conductivity.

If the source material has been resin impregnated, then preferably the resin is removed from the particles. Details of the resin removal are further described below.

Once the source material is comminuted, and any resin is removed, it is then re-expanded. The re-expansion may occur by using the intercalation and exfoliation process described above and those described in U.S. Pat. No. 3,404,061 to Shane et al. and U.S. Pat. No. 4,895,713 to Greinke et al.

Typically, after intercalation the particles are exfoliated by heating the intercalated particles in a furnace. During this exfoliation step, intercalated natural graphite flakes may be added to the recycled intercalated particles.

Preferably, during the re-expansion step the particles are expanded to have a specific volume in the range of at least about 100 cc/g and up to about 350 cc/g or greater.

Finally, after the re-expansion step, the re-expanded particles may be molded into flexible sheets having small transverse openings, as hereinafter described.

If the starting material has been impregnated with a resin, an important embodiment of the method of the present invention is removing at least part of the resin from the particles. This removal step should occur between the comminuting step and the re-expanding step.

In one embodiment, the removing step includes heating the resin containing regrind particles, such as over an open flame. More specifically, the impregnated resin may be heated to a temperature of at least about 250° C. to effect resin removal. During this heating step care should be taken to avoid flashing of the resin decomposition products; this can be done by careful heating in air or by heating in an inert atmosphere. Preferably, the heating should be in the range of from about 400 ° C. to about 800 ° C. for a time in the range of from at least about 10 and up to about 150 minutes or longer.

Additionally, the resin removal step may result in increased tensile strength of the resulting article produced from the molding process as compared to a similar method in which the resin is not removed.

The resin removal step may also be advantageous because during the expansion step (i.e., intercalation and exfoliation), when the resin is mixed with the intercalation chemicals, it may in certain instances create toxic byproducts.

Thus, by removing the resin before the expansion step a superior product is obtained such as the increased strength characteristics discussed above. The increased strength characteristics are a result of in part because of increased expansion. With the resin present in the particles, expansion may be restricted.

In addition to strength characteristics and environmental concerns, resin may be removed prior to intercalation in view of concerns about the resin possibly creating a run away exothermic reaction with the acid.

In view of the above, preferably a majority of the resin is removed. More preferably, greater than about 75% of the resin is removed. Most preferably, greater than 99% of the resin is removed.

Once the flexible graphite sheet is comminuted, it is molded into the desired shape and then cured (when resin impregnated) in the preferred embodiment. Alternatively, the sheet can be cured prior to being comminuted, although post-comminution cure is preferred. Molding can be by compression molding, isostatic molding or other like processes. Interestingly, the isotropy/anisotropy of the final article can be varied by the molding pressure, the particular molding process utilized and the size of the particles. For instance, compression molding will result in greater alignment of the graphene layers and, thus, a more anisotropic final product, than isostatic molding. Likewise, an increase in molding pressure will also result in an increase in anisotropy. Thus, adjustment of molding process and molding pressure, as well as selection of comminuted particle size, can lead to controllable variations in isotropy/anisotropy. Typical molding pressures employed range from under about 7 Mega Pascals (MPa) to at least about 240 MPa.

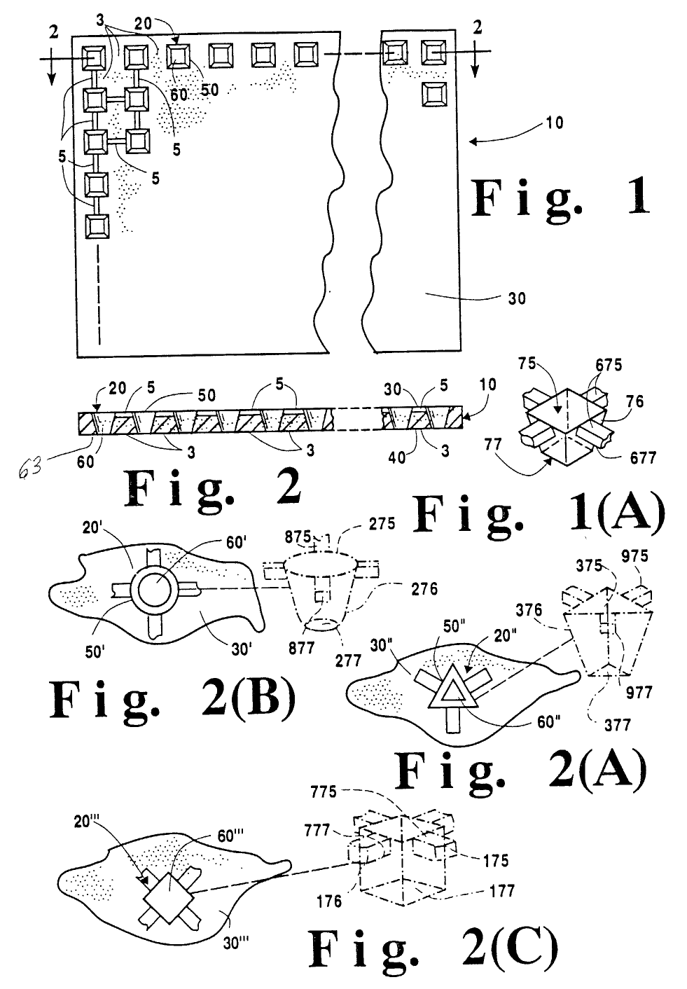

Detailed Description of the Preferred Embodiment of FIGS. 1-6

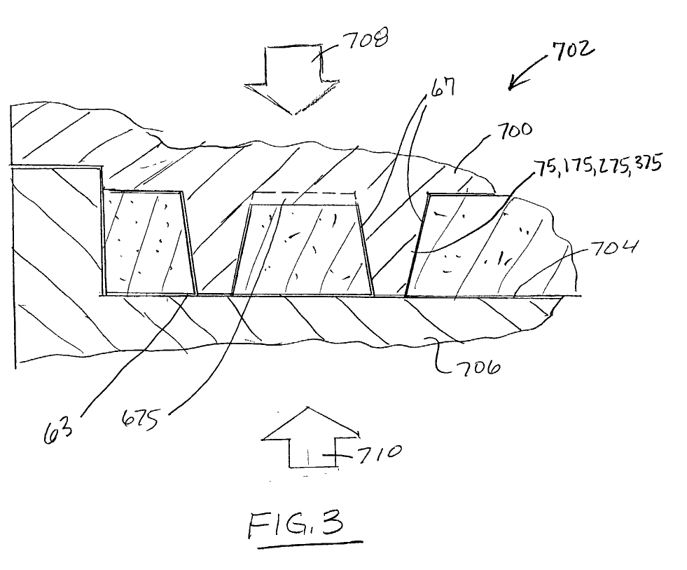

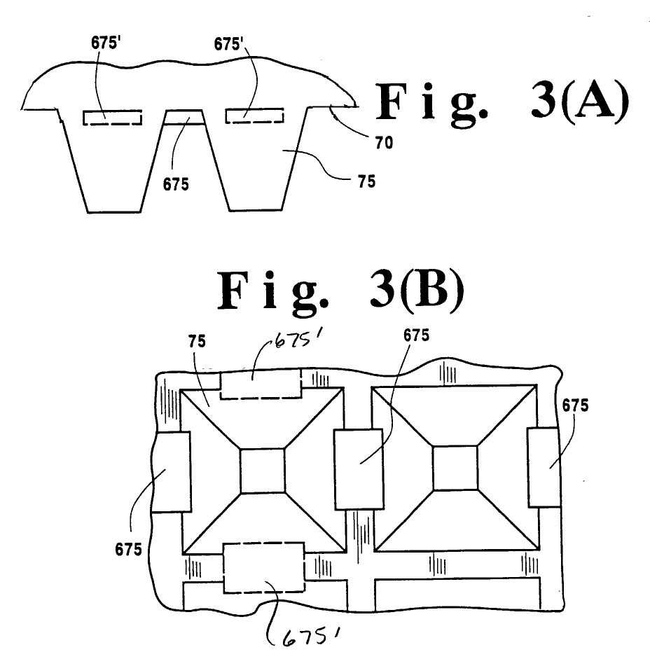

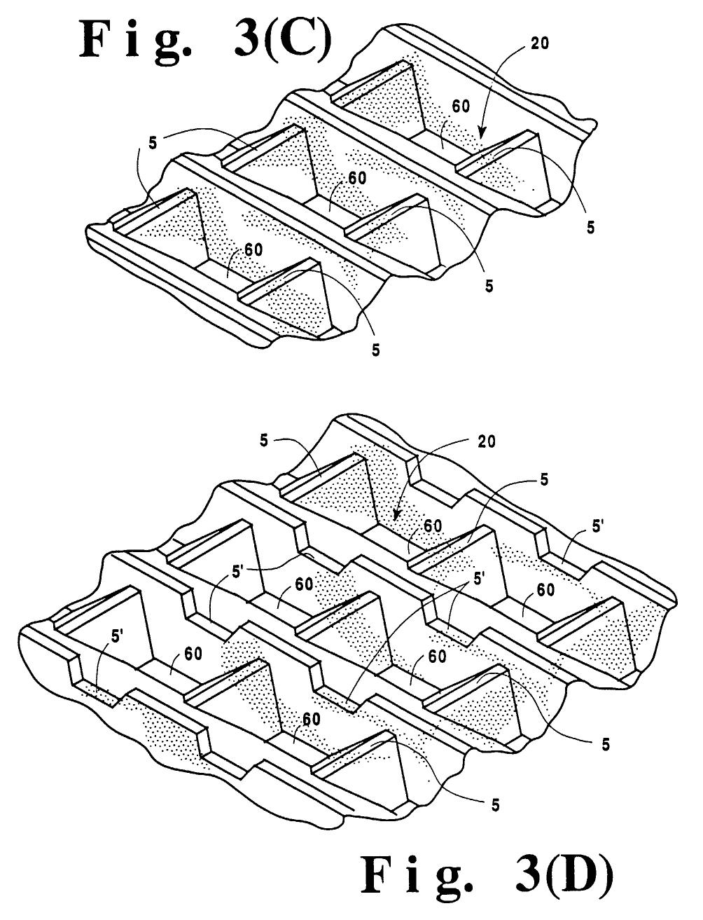

With reference to FIG. 1 and FIG. 2, a molded mass of expanded graphite particles, in the form of a flexible foraminous graphite sheet is shown at 10. The flexible graphite sheet 10 is provided with channels 20, which are preferably smooth-sided as indicated at 67 in FIG. 3, and which pass between the parallel, opposed surfaces 30, 40 of flexible graphite sheet 10, and are separated by walls 3 of compressed expandable graphite. The walls 3 are advantageously provided with grooves 5, having a depth of 1/10 to ⅓ the depth of the channels in accordance with the present invention. The channels 20 preferably have openings 50 on one of the opposed surfaces 30 which are larger than the openings 60 in the other opposed surface 40. The channels 20 can have different configurations as shown at 20′-20″′ in FIGS. 2(B), 2(A), 2(C) which are formed using flat-ended protrusion elements of different shapes as shown at 75, 175, 275, 375 in FIGS. 1(A) and 2(C), 2(B) and 2(A), suitably formed of metal, e.g. steel, and integral with and extending from the mold plunger 700 of a compression mold 702 shown in FIG. 3. The smooth flat-ends of the channel-forming protrusion elements 75, 175, 275, 375, shown at 77, 177, 277, 377, and the smooth flat ends of the groove-forming protrusion elements 675, 775, 875, 975 shown at 677, 777, 877, 977, and the smooth bearing surface 704, of mold cavity 706, of compression mold 702 meet to form the smaller openings 60, 60′, 60′ or 60″′. Preferred channel-forming protrusion elements 77 have decreasing cross-section in the direction away from the mold plunger 700 to provide larger channel openings on one side of the sheet. The development of smooth, unobstructed surfaces 63 surrounding channel openings 60, enables the free flow of fluid into and through smooth-sided (at 67) channels 20.

Alternatively, the protrusion elements may extend from the mold cavity 706, or from both the mold plunger 700 and mold cavity 706, to provide greater flexibility in the molding of desired patterns.

In a preferred embodiment, openings at one of the opposed surfaces are larger than the channel openings in the other opposed surface, e.g. from 1 to 200 times greater in area, and preferably from 50 to 150 times greater in area and result from the use of protrusion elements having converging sides such as shown at 76, 276, 376. The channels are present in a concentration up from 1000 to 3000 channels per square inch of the sheet 10. The transverse channels 20 are molded into the flexible graphite sheet 10 at a plurality of pre-determined locations by use of the compression mold 702 schematically illustrated in FIG. 3. The channel-forming protrusions 75 are bridged by groove-forming protrusions 675 which mold interconnecting grooves 5 between channels 20 in a row of aligned channels concurrently with molding of channels 20 which is illustrated in the sketch of FIG. 3(C). Additionally, groove-forming protrusion elements 675′ can be included as shown in FIGS. 3(A), 3(B) to form interconnecting grooves 5′ in a parallel row of transverse channels 20 as shown in FIG. 3(D).

Indeed, the protrusion elements, such as elements 75, 175, 275, 375 which mold channels 20 can also have varying sizes or configurations, in order to impart differing characteristics to flexible graphite sheet 10 at differing locations, most preferably in a selected pattern. For instance, it may be desirable to have the permeability of sheet 10 greater at certain locations than at others in order to, e.g., facilitate water vapor dispersal from or through flexible graphite sheet 10 where doing so may be needed or to equalize or accommodate fluid or gas pressure along flexible graphite sheet 10.

The particles of graphite material, be they virgin particles, recycled particles or a blend thereof, are loaded into the mold cavity and then placed under compression by a load applied in the direction of the arrows 708 and 710. The particles can be compressed under pressures of at least about 100 lb/in², and more preferably under pressures from about 600 to about 10,000 lb/in².

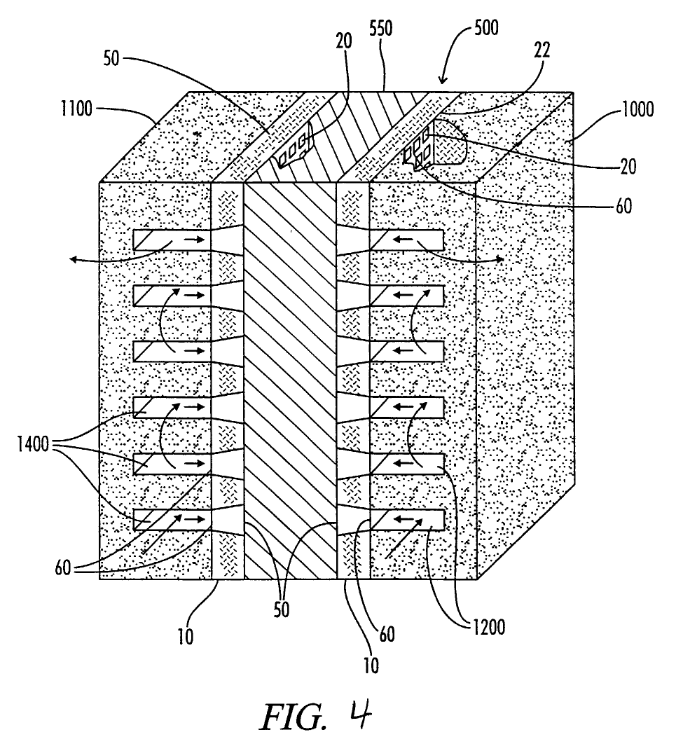

The perforated gas permeable flexible graphite sheet 10 of FIG. 1 is used as an electrode in an electrochemical fuel cell 500 shown schematically in FIGS. 4, 5 and 6.

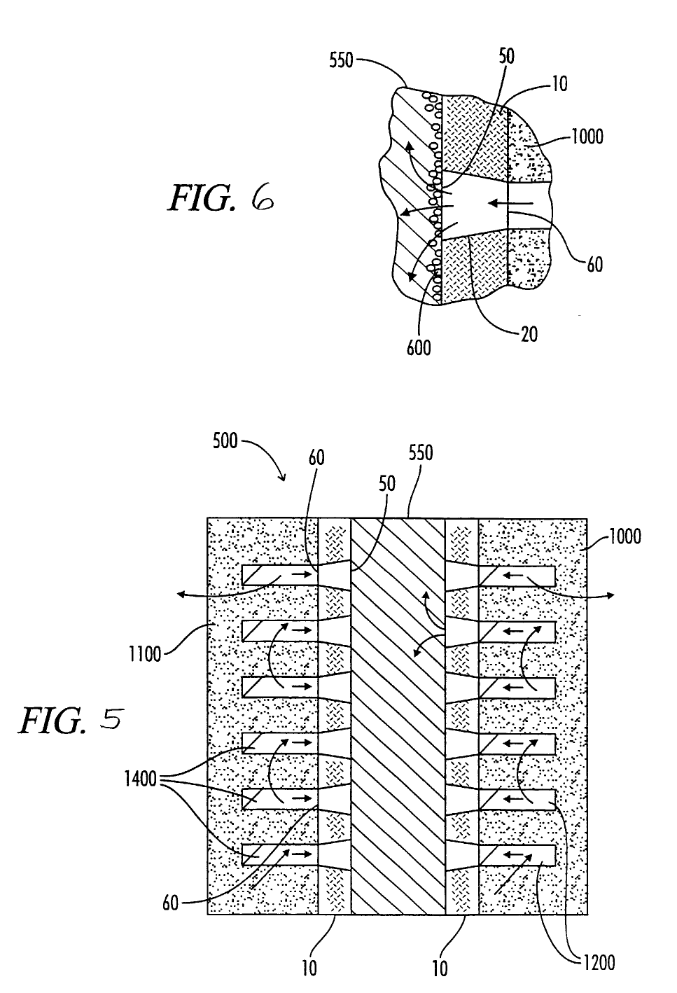

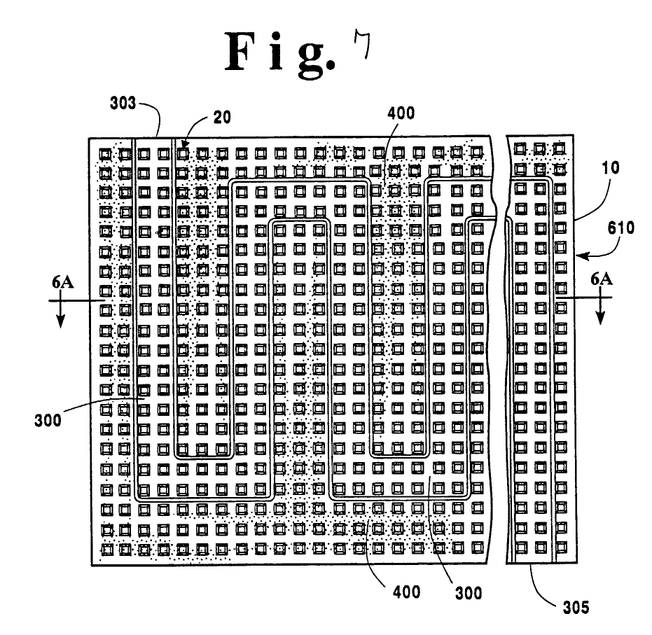

FIG. 4, FIG. 5 and FIG. 6 show, schematically, the basic elements of an electrochemical Fuel Cell, more complete details of which are disclosed in U.S. Pat. Nos. 4,988,583 and 5,300,370 and PCT WO 95/16287 (Jun. 15, 1995) and each of which is incorporated herein by reference.

With reference to FIG. 4, FIG. 5 and FIG. 6, the Fuel Cell indicated generally at 500, comprises electrolyte in the form of a plastic e.g. a solid polymer ion exchange membrane 550; perforated flexible graphite sheet electrodes 10 in accordance with the present invention; and flow field plates 1000, 1100 which respectively abut electrodes 10. Pressurized fuel is circulated through grooves 1400 of fuel flow field pate 1100 and pressurized oxidant is circulated through grooves 1200. In operation, the fuel flow field plate 1100 becomes an anode, and the oxidant flow field plate 1000 becomes a cathode with the result that an electric potential, i.e. voltage is developed between the fuel flow field plate 1000 and the oxidant flow field plate 1100. The above described electrochemical fuel cell is combined with others in a fuel cell stack to provide the desired level of electric power as described in the above-noted U.S. Pat. No. 5,300,370.

One significant difference lies in the fact that the catalyst 600 is selectively loaded on the surfaces of the solid polymer exchange membrane 550. In this way, the catalyst metal is only present in a selected pattern on membrane 550 rather than relatively uniformly distributed thereon and, therefore, the amount of catalyst employed is minimized while maximizing the effectiveness of the catalyst. This is because catalyst is now only disposed on the surfaces of the membrane where the walls 3 of channels 20 abut membrane 550.

The operation of Fuel Cell 500 requires that the electrodes 10 be porous to the fuel and oxidant fluids, e.g. hydrogen and oxygen, to permit these components to readily pass from the grooves 1400, 1200 through electrodes 10 to contact the catalyst 600 on the surfaces of the membrane 550, as shown in FIG. 6, and enable protons derived from hydrogen to migrate through ion exchange membrane 550. In the electrode 10 of the present invention, channels 20 are positioned to adjacently cover grooves 1400, 1200 of the flow field plates so that the pressurized gas from the grooves passes through the smaller openings 60 of channels 20 and exits the larger openings 50 of channels 20. The initial velocity of the gas at the smaller openings 60 is higher than the gas flow at the larger openings 50 with the result that the gas is slowed down when it contacts the catalyst 600 on the surface of membrane 550 and the residence time of gas-catalyst contact is increased and the area of gas exposure at the membrane 550 is maximized. This feature, together with the increased electrical conductivity of the flexible graphite electrode of the present invention enables more efficient fuel cell operation.

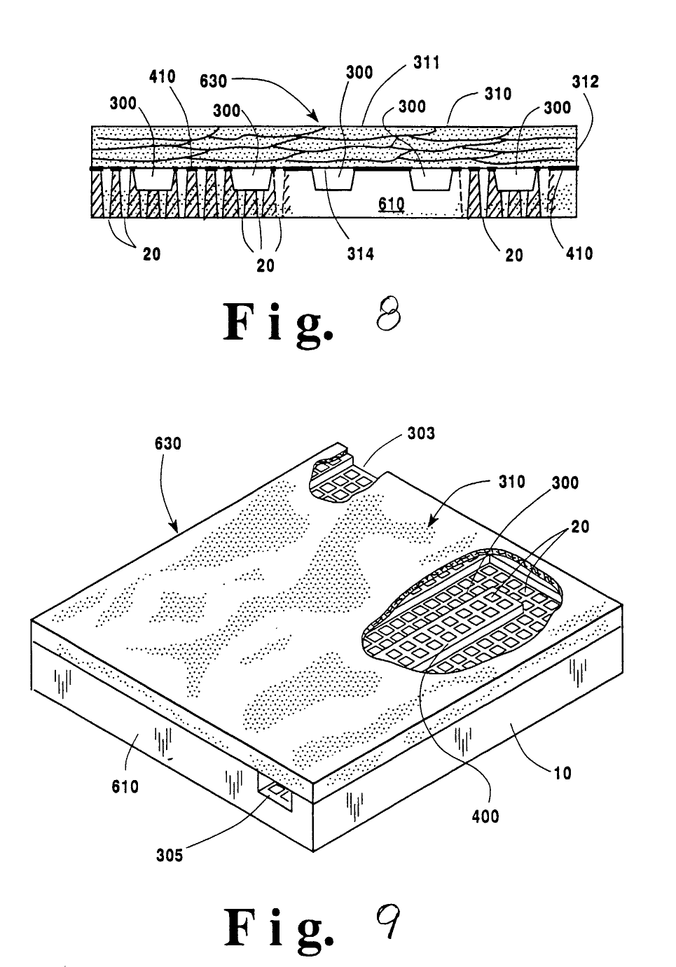

FIGS. 7-9: Molding of Open Grooves

In the practice of the present invention, with reference to FIG. 7, a gas permeable flexible graphite sheet 10, having transverse channels 20, as shown in FIG. 1, is provided, at its upper surface 30 with a continuous, open groove 300, fluid inlet 303 and fluid outlet 305 to constitute a gas diffusing electrode 610. The groove 300 of the present invention is suitably formed by molding the same simultaneously with the molding of the sheet 10 and channels 20. The mold forms a continuous open groove 300 in the surface 30 and for a sheet of flexible graphite 0.15 mm to 3.2 mm thick, is suitably 0.075 mm to 3.0 mm deep and 0.5 mm to 6.4 mm wide separated by raised portions 400 e.g. 0.25 mm to 1.5 mm wide.

The device shown in FIGS. 8 and 9 is an electrode 630 in the form of a combination of a grooved gas permeable body of flexible graphite 610 with a flexible graphite cover element 310.

Cover element 310 shown in FIGS. 8 and 9 is a thin flexible graphite sheet (0.075 mm to 0.25 mm) that has been roll pressed and calendered to a relatively high density, e.g. 0.9. to 1.5 g/cc. The roll pressed and calendered sheet 310 has a very high degree of anisotropy with respect to thermal conductivity. The thermal conductivity in directions in the plane of the flexible graphite sheet (“a” direction) is typically 30 to 70 times the thermal conductivity in the direction through the flexible graphite sheet (“c”direction). Consequently, heat generated in the fuel cell 500 shown in FIGS. 4, 5, and 6, e.g. at catalyst 600, due to electric current flow, is conducted through gas diffusing electrode 610 to the abutting and contiguous flexible graphite sheet covering element 310 and then rapidly conducted, parallel to the opposed surfaces 311, 314 of the graphite sheet 310, due to high heat conductivity in this direction (“a”), to the edges 312 of flexible graphite sheet cover element 310, where the heat can be readily dissipated by convection. The need for incorporating cooler cells, or elements, in a stack of fuel cells is thus minimized.

In order to achieve optimum bonding between flexible graphite sheet cover element 310 and gas diffusion electrode 610, graphite sheet cover element 310 is impregnated with a resin (e.g. by immersion in a solution of modified phenolic resin in alcohol) and the resin containing flexible graphite sheet 30 is placed in contact with the raised portion 400 of grooved surface 30 or 40, of gas diffusion electrode 610 and heated to cure the resin and form a bond 410 at the lands 400 of the grooved surface. This is conveniently accomplished by placing the resin impregnated cover element 310 on a flat metal surface and lightly pressing the gas diffusion electrode 610 against the resin impregnated cover element 310 while heating the cover element 310 to a temperature sufficient to cure the resin and effect bonding, typically 170° C. to 400° C. Alternatively, bonding can be accomplished by coating the raised portions 400 of the die formed grooved surface of the gas diffusion layer with a similar resin and bonding and curing the cover element in place as previously described.

The Internal Structure of Molded Materials

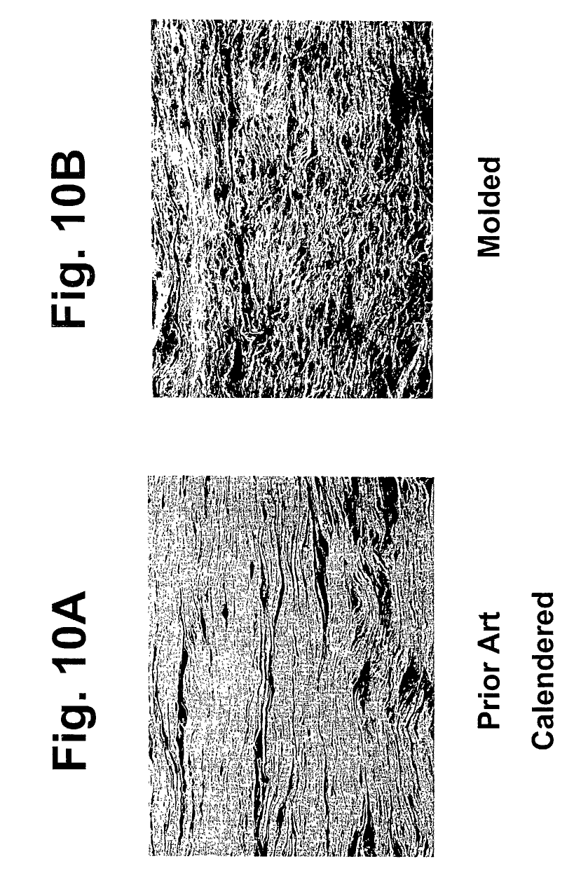

The internal structure of the material of FIG. 1 is shown in FIG. 10(B). FIG. 10(B) is a photomicrograph of a compression molded mass of expanded particles of natural graphite. It is shown in a side-by-side comparison to the photomicrograph in FIG. 10(A) of the internal structure of a prior art calendered graphite material. As is apparent in comparing FIG. 10(B) to FIG. 10(A), the internal orientation of the graphite particles in the molded material of FIG. 10(B) is considerably less anisotropic than is the orientation of the particles in the calendered prior art material of FIG. 10(A). This results in increased thermal and electrical conductivity in the direction transverse to the opposed parallel planar surfaces 30 and 40 of the molded material of FIG. 1 and FIG. 10(B) as compared to the thermal and electrical conductivity in the transverse direction of the prior art material of FIG. 10(A).

The examples shown in FIGS. 10(A) and 10(B) were both compressed to the same density. The molded material of FIG. 10(B) was molded at a pressure of 700 lb/in².

In one example, thermal conductivities were compared for similar calendered and molded materials. The thermal conductivity for the molded material was 6 W/m^{O}K, as compared to only 4 W/m^{O}K for the calendered material.

All cited patents and publications referred to in this application are incorporated by reference.

The invention thus being described, it will be obvious that it may be varied in many ways. Such variations are not to be regarded as a departure from the spirit and scope of the present invention and all such modifications as would be obvious to one skilled in the art are intended to be included within the scope of the following claims.

We claim:

1. A method of manufacturing a material useful in forming a fuel cell component, comprising:
(a) providing a mass of expanded particles of natural graphite; and
(b) molding the mass of expanded particles of natural graphite into a foraminous sheet having parallel opposed first and second surfaces and having a plurality of transverse fluid channels passing through said sheet between said first and second parallel opposed surfaces.

2. The method of claim 1, wherein:
said molding step (b) provides a material with greater through thickness electrical conductivity than does a substantially similarly dimensioned calendered sheet of graphite material.

3. The method of claim 1, wherein:
step (a) comprises using virgin material for at least a portion of the mass of expanded particles of natural graphite, and includes the steps of:
(a)(1) providing natural graphite flakes;
(a)(2) intercalating the natural graphite flakes;
(a)(3) heating the intercalated natural graphite flakes and expanding the flakes into vermiform expanded graphite particles; and
step (b) comprises molding the vermiform expanded graphite particles.

4. The method of claim 1, wherein:
step (a) comprises using recycled material for at least a portion of the mass of expanded particles of natural graphite, and includes the steps of:
(a)(1) providing source materials in the form of flexible sheets of expanded graphite;
(a)(2) comminuting the source materials into particles; and
(a)(3) re-expanding the particles; and
step (b) comprises molding the re-expanded particles.

5. The method of claim 1, wherein step (a) comprises using a blend of virgin material and recycled material for the mass of expanded particles of natural graphite.

6. The method of claim 1, wherein step (b) comprises compression molding the mass of expanded particles of natural graphite.

7. The method of claim 1, wherein step (b) further comprises:
molding said transverse fluid channels so that channel openings at said first surface are larger than channel openings at said second surface.

8. The method of claim 1, wherein step (b) further comprises:
molding said transverse fluid channels so that channel openings at said first surface are from 50 to 150 times larger in area than the channel openings at said second surface.

9. The method of claim 1, wherein step (b) further comprises:
molding said transverse fluid channels so that from 1000 to 3000 channels per square inch are present in said sheet.

10. The method of claim 1, wherein step (b) further comprises:
simultaneously with the molding of the sheet and the channels, molding grooves interconnecting at least some of the channels.

11. The method of claim 1, further comprising:
selectively loading catalyst on at least one of said first and second surfaces.

12. The method of claim 11, wherein step (b) further comprises:
molding the plurality of transverse fluid channels in a pattern which varies across said first surface; and
wherein said selectively loading step includes loading said catalyst in a pattern corresponding to the pattern of the transverse fluid channels.

13. The method of claim 1, wherein step (b) further comprises:
simultaneously with the molding of the sheet and the channels, molding an open groove having a width spanning at least two of said channels and having a length extending across a majority of a length or a width of said sheet.

14. The method of claim 13, further comprising:
providing a cover over said open groove.

15. A material useful in forming a fuel cell component, comprising a molded foraminous sheet having parallel opposed first and second surfaces and having a plurality of transverse fluid channels passing through the sheet between said first and second parallel opposed surfaces, the sheet including a molded mass of expanded particles of natural graphite having a greater through thickness electrical conductivity than does a substantially similarly dimensioned calendered sheet of graphite material.

16. The material of claim 15, wherein channel openings at said first surface are larger than channel openings at said second surface.

17. The material of claim 16, wherein the channel openings at said first surface are from 50 to 150 times larger in area than the channel openings at said second surface.

18. The material of claim 15, wherein the sheet comprises from 1000 to 3000 channels per square inch of the sheet.

19. The material of claim 15, wherein the sheet comprises molded grooves in the first surface interconnecting at least some of the channels.

20. The material of claim 15, further comprising catalyst loaded on at least one of the first and second surfaces.

21. The material of claim 15, wherein the sheet comprises a molded open groove having a width spanning at least two of said channels and having a length extending across a majority of a length or a width of the sheet.
